(19) United States
(12) Patent Application Publication
(10) Pub. No.: US 2012/0226616 A1
(43) Pub. Date: Sep. 6, 2012

(54) VIRTUAL GOODS INCENTIVE SYSTEM

(76) Inventors: Michael Amar, Palo Alto, CA (US); Dimitri Ducourtieux, Feriey (FR); Suchit Dash, San Francisco, CA (US); Vida Ha, Mountain View, CA (US); Scott Silverman, Falls Church, VA (US)

(21) Appl. No.: 13/293,098

(22) Filed: Nov. 9, 2011

Related U.S. Application Data
(60) Provisional application No. 61/448,062, filed on Mar. 1, 2011.

(51) Int. Cl. G06Q 30/02; H04L 9/32

(52) U.S. Cl. 705/50; 705/14.1; 705/14.39

(57) ABSTRACT

Virtual goods, such as Facebook credits or Farmville animals, are offered as an incentive to acquire new customers or reacquire former customers. Using a simple click-through process, a customer may receive a given number of virtual credits, or a particular virtual item, upon satisfying a given requirement, such as a purchase above a given amount, a subscription to a mailing list, submission of a preference profile, and so on. Initial tests have indicated that a substantial number of customers prefer receiving such virtual items in lieu of a cash rebate or other cash-based discount, even when the actual cost associated with the virtual item is the same as, or lower than the amount of the cash-based discount. In a preferred embodiment, a third-party campaign manager facilitates the execution and management of the incentive campaign.

This application claims the benefit of U.S. Provisional Patent Application 61/448,062, filed 1 Mar. 2011.

### BACKGROUND AND SUMMARY OF THE INVENTION

This invention relates to the field of online marketing and sales, and in particular to a system and method for providing promotions and incentives for free “virtual goods” as an incentive for customer actions, such as making a purchase, subscribing to an email newsletter, joining a social networking group, writing a review, and so on.

The costs associated with acquiring a customer is often a significant overhead cost to a retailer. It is estimated that a typical program to acquire a customer, or reacquire a former customer, costs a retailer about $10 per acquired customer. Further, merely offering a cash rebate or discount does not necessarily distinguish the vendor from any other vendor offering the same product at the same discounted price, and in a competitive market, rarely does a single purchase at a discounted price instill a sense of customer loyalty.

It is also difficult for a typical retailer to create a list of potential customers that are likely to be interested in the particular products that the retailer offers. Retailers may be willing to provide an incentive to potential customers who subscribe to their mailings, or who are willing to provide personal data to facilitate targeted advertisements, and so on, but the logistics and costs associated with providing such incentives outside a current sales transaction often makes it infeasible to launch such incentives. Additionally, because such incentive programs are intended to be offered to a large number of people, the cost per respondent must be minimized, and minimized cash-based incentives, such as a rebate of 50 cents, is not likely to generate much interest. Additionally, the cost of delivering such a minimal rebate can be prohibitive due to transaction fees associated with the payment networks.

It would be advantageous to be able to offer an incentive to a potential customer that is perceived as something desirable, distinguishes the retailer from other retailers, and provides an opportunity to personalize subsequent interactions with the customer. It would also be advantageous if providing this incentive is less costly than a conventional cash-based incentive program. (For ease of reference, the term ‘cash-based’ is used herein to include any incentive program that provides a positive cash flow to the customer, including, for example, percentage or fixed discounts, cash rebates, reduced shipping costs, and so on.)

The inventors have recognized that social networking and, in particular, social gaming has become one of the largest growing, if not the largest growing field of endeavors in the past few years. It is estimated that over 290 million people monthly engage in social gaming today, with revenues amounting to over a billion dollars, and that these revenues will increase to over five billion dollars by 2015.

A substantial amount of the current and projected revenue is revenue generated by in-game transactions, wherein a user may purchase a “virtual” item that facilitates advancement in the game. For example, to advance to a next level in a game may consume hours of the user's time; alternatively, the user may purchase a virtual ‘credit’, and use this virtual credit to advance to the next level immediately. In like manner, a user may purchase a virtual tool or virtual weapon for use by the user's avatar to achieve particular tasks and goals, or a user may purchase a virtual animal or virtual seeds to facilitate growth or expansion of a virtual farm.

The inventors have also recognized that although there are millions of people engaged in social gaming, very few of these ‘gamers’ are willing to actually purchase the aforementioned virtual items for use in the games. A current estimate is that only about two to three percent of the current gamers are willing to purchase such virtual items.

The inventors believe that most gamers view virtual goods as desirable, but are reluctant to enact an actual cash transaction to purchase these virtual goods. This reluctance may be based on any number of factors, such as reluctance to disclose a credit card number within a social gaming environment, a reluctance to go through the bother of a transaction, a reluctance to pay actual cash for ‘make believe’ goods, and so on.

It would be advantageous to combine the need for novel incentive programs with the expected growth and increased involvement in social gaming. It would also be advantageous to provide a simple process for obtaining virtual goods without purchasing them directly.

These advantages, and others, can be realized by offering ‘virtual’ goods as an incentive to acquire new customers or reacquire former customers. Using a simple click-through process, a customer may receive a given number of virtual credits, or a particular virtual item, upon satisfying a given requirement, such as a purchase above a given amount, a subscription to a mailing list, submission of a preference profile, and so on. Initial tests have indicated that a substantial number of customers prefer receiving such virtual items in lieu of a cash rebate or other cash-based discount, even when the actual cost associated with the virtual item is the same as, or lower than the amount of the cash-based discount. Because the entire transaction is accomplished on-line, with no actual cash being transferred, the logistics associated with launching and executing the campaign are low enough to facilitate hi-volume, low-cost incentive programs. In a preferred embodiment, a third-party campaign manager facilitates the execution and management of the incentive campaign.

### BRIEF DESCRIPTION OF THE DRAWINGS

The invention is explained in further detail, and by way of example, with reference to the accompanying drawings wherein:

FIG. 1 illustrates an example flow diagram for a virtual goods incentive system.

FIGS. 2A-2D illustrate example screen shots provided to the customer by the virtual goods incentive system.

FIG. 3 illustrates an example flow diagram for a virtual goods incentive system using a third-party campaign manager.

FIGS. 4A-4B illustrate example code for inclusion in a retailer's web-page to enable a third party to manage an incentive campaign for the retailer.

FIGS. 5A-5E illustrate statistics and metrics associated with sales campaigns that offered virtual goods in return for purchases of actual goods.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

For the purposes of this disclosure, the terms “virtual” and “actual” are used herein to distinguish elements that exist only within an artificial, or software, environment from those that exist in reality. A virtual cow, for example, is a simulacrum in a virtual environment that performs in the virtual environment in a manner similar to an actual cow on an actual farm. Virtual cash, in like manner, is used in a virtual environment in a manner similar to actual cash in the physical world.

Obviously, because virtual goods do not represent actual assets, there is no real ‘cost’ associated with the virtual goods, other than the nominal cost defined by the virtual environment provider for obtaining such virtual goods. Accordingly, the nominally defined cost to provide a virtual cow, for example, will be substantially less than the actual cost to provide a live cow. In like manner, a nominally defined cost of providing credits that can be used to save hours of gaming time achieving a goal will be substantially less than an actual cost associated with the gamer's time.

The invention is premised on the observation that social gamers perceive virtual goods, such as Facebook credits, Cityville cash, Farmville animals, and the like, as being valuable, and that if a simple and straightforward interface were provided to easily obtain such virtual goods, more gamers would begin using virtual goods to enhance their gaming enjoyment.

This invention is also premised on the observation that offering virtual goods, instead of actual goods, as an incentive by a retailer will distinguish this retailer from other retailers, and if the overall value associated with obtaining the virtual goods is perceived by the customer as being more desirable than actual goods having a higher cost to the retailer, the cost of providing the virtual goods incentive will be less.

A further advantage of coupling an incentive program to social gaming is that the gaming environment typically includes a profile of each gamer, and this profile may be used to facilitate subsequent contacts with the gamer, encouraging further interactions with the retailer.

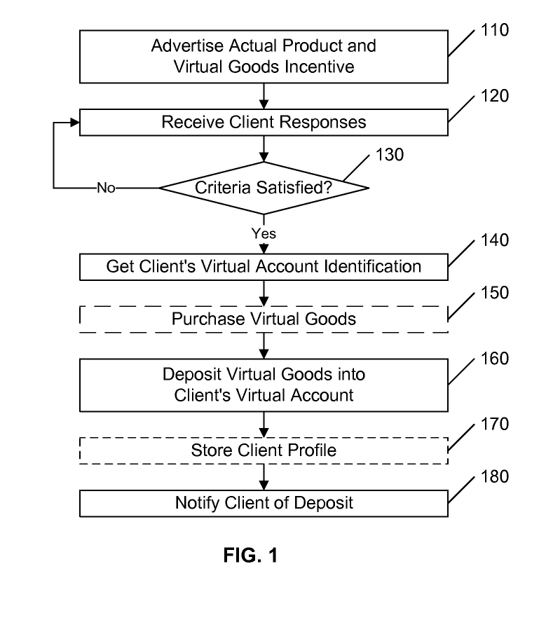

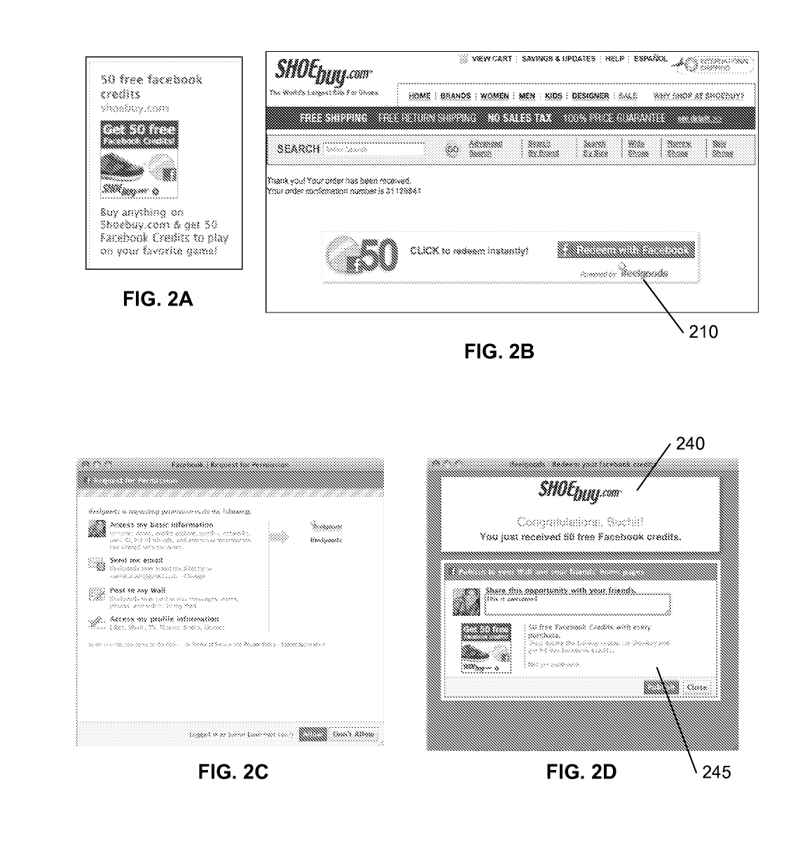

FIG. 1 illustrates an example flow diagram for a virtual goods incentive system, and FIGS. 2A-2D illustrate example screen shots of an example system. For the purposes of this disclosure, the term ‘client’ is used hereinafter to identify the ‘target’ of the incentive program; that is, the person from whom a desired action is solicited, such as a purchase, a subscription, a response, and so on. For ease of understanding, this invention is presented in the context of offering virtual goods as an incentive for purchasing actual goods, although one of skill in the art will recognize that virtual goods may be offered as an incentive for other actions on the part of the client.

At 110, the offer for the actual goods and the incentive of obtaining virtual goods is advertized to the client. An example advertisement for receiving fifty Facebook credits with any purchase is illustrated in FIG. 2A.

At 120, the client's responses are received and processed. Such responses may include typical web-page interactions, click-throughs, searches, and so on. At some point, the client may perform the desired purchase of the actual goods, and, at 130, the system will proceed to satisfy the advertized offer. An example action-completed message is illustrated in FIG. 2B, advising the client that the desired action was performed, and inviting 210 the client to proceed to redeem the advertized offer for virtual goods, in this case, the aforementioned fifty Facebook credits.

To initiate the redemption process, the system queries the user to obtain the information necessary to effect the transfer of the virtual goods to the user's virtual account, at 140. The particular procedure for accessing the client's virtual account and provide a deposit will be dependent upon the particular virtual environment associated with the virtual account. Most virtual environments allow users to ‘gift’ credits from one user to another, and in a preferred embodiment, the provider of the incentive establishes a relationship with the provider of the environment to facilitate such transfers.

In the example of a deposit to a Facebook account, FIG. 2C illustrates an example Facebook ‘Request for Permission’ page. In a preferred embodiment of this invention, in addition to requesting permission to post to the user's Facebook wall in order to make the actual deposit, the system also requests permission to obtain the user's e-mail address and to access the user's profile information. The e-mail address is nominally requested for sending a confirmation e-mail regarding the deposit of the virtual goods, but also serves to allow the retailer to send targeted e-mails to the client with other offers and incentives and to validate the email inputted to ensure quality leads & information about the customer. The client's profile information may be stored 170 and subsequently used to determine the client's preferences and demographics, to facilitate selective targeting and personalization.

For example, the client's profile information may indicate that the client is a frequent Farmville gamer, and a targeted incentive could include virtual farm animals; in like manner, if the client is not a Farmville gamer, Farmville-based virtual objects would not be offered, or an offer to join Farmville might be offered. The profile information may also be used to identify actual objects that the client may have an interest in, based on the client's gender, age, expressed interests, and so on. For example, if the client indicates that he/she is an avid runner, offers for high-performance sneakers may be appropriate.

At 180, the client is notified of the virtual goods deposit; FIG. 2D illustrates such an example notice 240. Also illustrated at 245 in FIG. 2D, the client is provided the opportunity to publish an opinion of the transaction, including the original advertisement of FIG. 2A. In a preferred embodiment, this publication may also be sent to the client's friends on Facebook. Optionally, the user's agreement to publish the opinion may also result in the deposit of additional virtual objects into the client's virtual account.

Although the above material describes the general concepts of this invention, the inventors have also recognized that providing this interaction with virtual environments and virtual accounts is not necessarily an activity that fits within the interests or skill-sets of a conventional actual goods retailer. In like manner, increasing a client's balance in a virtual account is not necessarily an activity that the provider of the virtual account would want to be performed by any and all retailers. The risk of fraud and the overhead associated with maintaining actual accounts for receiving the deposits of actual funds corresponding to the purchase of virtual goods that are deposited to the various client virtual accounts, as well as the potential need to mitigate disputes between the client and the retailer, may be a significant disincentive for the provider of the client virtual accounts. Conventionally, although the transfer of credits or goods between a gamer and the provider of the game is controlled by the provider of the game, the purchase of virtual credits using actual funds is generally solely controlled by the provider of the virtual account.

In a preferred embodiment of this invention, a third-party campaign manager provides the interface among the virtual account provider, the retailer, and the client. Preferably, the third party campaign manager warrants the transfer of actual funds to the virtual account provider and the transfer of virtual goods to the client on behalf of the retailer. In this manner, the retailer need not become involved in the logistics and details associated with implementing the virtual goods transfers, and the provider of the virtual account is able to grant explicit authorization to a limited number of parties that are authorized to increase the balance in any client's virtual account.

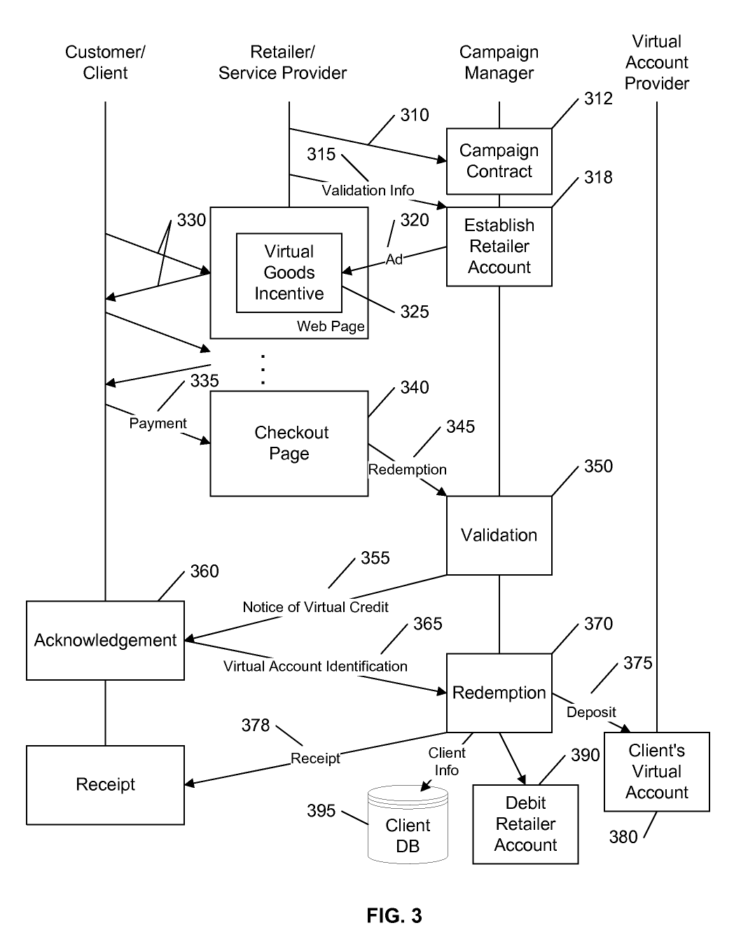

FIG. 3 illustrates an example flow diagram for a virtual goods incentive system using a third-party campaign manager.

A retailer that desires to add a virtual goods incentive program to an advertising program for actual goods contacts 310 the campaign manager and enters into a contract 312 with the campaign manager. The contract may take any number of forms, including a fixed price contract, but in general, a commission-based contract is particularly well suited for marketing campaigns. Generally, the campaign manager will establish an account 318 for the retailer, with a fixed ceiling amount that sets an upper limit to the cost of providing the virtual goods incentive. Associated with this account is confidential information 315 associated with the retailer that serves to validate transactions related to the retailer's account, as detailed further below. Depending upon the particular contract, the retailer may be required to provide a down payment of actual funds to support the campaign, and/or to replenish the actual funds as the balance in the account is drawn down by the purchase of the virtual goods that are transferred to the clients.

In an example embodiment of this invention, the campaign manager provides 320 the advertisement 325 for the virtual goods incentive, such as the advertisement illustrated in FIG. 2A. Preferably, instantiating the advertisement 325 establishes a link to the campaign manager, and the incentive is displayed only if the actual costs expended for the virtual goods incentive is below the aforementioned ceiling amount established for the retailer's account.

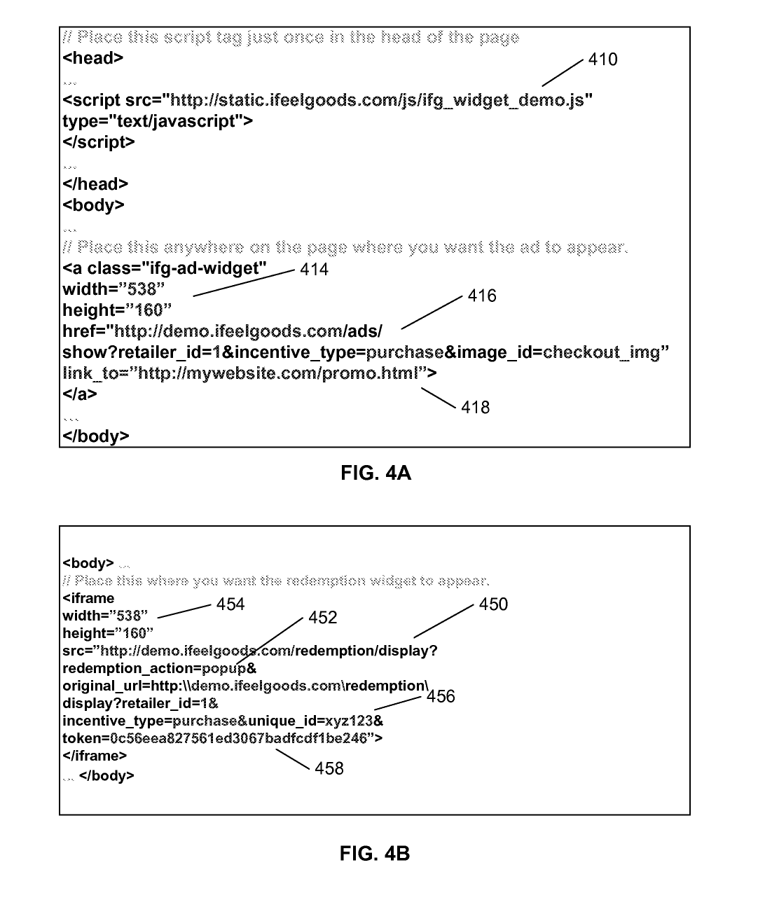

FIG. 4A illustrates example javascript code for instantiating an advertisement for a virtual goods incentive in a retailer's web page. Within the header of the retailer's web page, the retailer inserts an identifier 410 of the location of the javascript program (“ifg_widget_demo.js”) at the campaign manager's site (“static.ifeelgoods.com”) that renders the advertisement. Techniques for rendering advertisements on a web site are common in the art, and need not be detailed further herein.

To instantiate the advertisement at a particular location on the web site, the retailer inserts the call (href) 416 to the advertisement at the desired location, with a given width and height 414. The href 416 identifies the location of the ad at the campaign manager's site (“demo.ifeelgoods.com/ads”), referencing the particular retailer (“retailer_id=1”), the type of incentive (“incentive_type=purchase”), and the image that forms the advertisement (“image_id=checkout_img”). Using this information, the aforementioned javascript program (“ifg_widget_demo.js”) checks the account associated with the identified retailer and the identified incentive, and renders the identified image if the costs associated with the incentive are below the aforementioned ceiling.

Optionally, the retailer may link the incentive advertisement to another page 418 on the retailer's site, such that a ‘click’ on the advertisement will transfer the client to that other page.

Returning to FIG. 3, the client interacts 330 with the retailer's web site, and, in this example, eventually executes a purchase for an actual object and remits payment 335 while interacting with the checkout page 340. Upon completion of the purchase, the retailer notifies 345 the campaign manager that the purchase has been completed, and instructs the campaign manager to redeem the offer of virtual goods for the client.

FIG. 4B illustrates example javascript code for implementing this redemption process at the retailer's web site. As in FIG. 4A, the retailer places the indicated code at a desired location on the web page, and identifies a desired width and height 454 for rendering the redemption, which in this case is in the form of a popup.

The call (src) 450 to the redemption process at the campaign manager's web site (“demo.ifeelgoods.com/redemption/display”) includes the aforementioned identification of the retailer (“retailer_id=1”), and type of incentive (“incentive_type=purchase”), from which the appropriate campaign and corresponding retailer account may be identified.

To avoid fraudulent redemptions, two additional parameters are also communicated to the campaign manager, a unique identifier (“unique_id=xyz123”) 456 of the particular client transaction, and a secure token (“token=0c56 . . . ”) 458 that is used to validate that this redemption is authorized by the identified retailer.

Any number of symmetric or asymmetric encryption techniques may be used to create the token. In a symmetric encryption, both the retailer and the campaign manner possess a key that is known only to these parties, and an encryption of an element by the retailer using the key can be decrypted by the campaign manager using the same key to reproduce the encrypted element. In an asymmetric encryption, the retailer possesses a private key that is known only to the retailer, and the campaign manager possesses a corresponding public key that may be known to others as well. An encryption of an element using the retailer's private key can be decrypted using the corresponding public key to reproduce the encrypted element. In either encryption method, the campaign manager must be informed of the element that is being encrypted, for comparison with the result of the decryption. In an example embodiment, because the unique identifier is unique to the retailer and included in the redemption request, the encrypted element is preferably this unique identifier.

For example, the token may be created using a Hash-based Message Authentication Code (HMAC) using the MD5 hash function, which is a symmetric encryption technique. In this example embodiment, as part of the campaign contract between the campaign manager and the retailer, the retailer is assigned a unique key that is known only to the retailer and the campaign manager. When the client transaction is completed, the unique identifier is encoded by the retailer using the retailer's key to produce the token (e.g., using php code: “$token=hash_hmac (‘md5’, $unique_id, $retailer_key)”).

Returning to FIG. 3, upon receipt of the parameters in the redemption message 345 from the retailer, the campaign manager validates that the redemption message is a proper and authorized redemption request, at 350.

To validate that the redemption message was created by the particular vendor identified in the redemption message, the campaign manager decrypts the encrypted element using the decryption process corresponding to the encrypting process used by the retailer. In the above HMAC-MD5 encryption example, the campaign manager executes the same HMAC function, using the communicated token and the secret key associated with the particular retailer (e.g. “$result=hash_hmac(‘md5’, $token, $retailer_key)”). If the communicated token was a proper encryption of the unique identifier using the retailer's key, the result of this operation on the token at the campaign manager site will be the unique identifier. If the determined result does not match the communicated unique identifier, the redemption is not executed and the process is terminated with an “invalid redemption request” error message.

If the determined result matches the unique identifier, the campaign manager verifies that this redemption request is not a duplicate request by checking the retailer's account for this unique identifier. As detailed below, when a redemption request is granted, the campaign manager records the redemption in the retailer's account, including the unique identifier. If the current unique identifier is already entered in the retailer's account, the redemption is not executed and the process is terminated with an “already redeemed” error message.

After validating that the redemption request is authorized by the retailer, and not a repeat of a previously granted redemption request, the campaign manager notifies 355 the client that the redemption process for the offered virtual goods is underway. The client acknowledges the transaction by providing the necessary information 365 for accessing the client's virtual account 380. In the example of Facebook virtual goods, the client allows the campaign manager to access the client's Facebook information and to post to the client's wall, as detailed above with respect to FIG. 2C. Other virtual environments may provide different protocols and APIs (Application Program Interfaces) for accessing a client's virtual account to make deposits.

Upon receipt of the identification of the client's account, the campaign manager deposits 375 the offered virtual goods into the client's virtual account 380, notifies 378 the client of the deposit, and records 390 this deposit in the retailer's account.

The recordation 390 of the deposit in the retailer's account includes the details associated with the redemption, such as the unique identifier of the redemption, and also effects a debit to the retailer's account, reducing the amount available to fund subsequent redemptions. If this redemption causes the cost of providing the campaign to reach (or approach) the aforementioned ceiling, the retailer is notified, and offered the opportunity to increase the ceiling to continue the incentive program.

As noted above, in addition to gaining access to the client's virtual account to deposit the virtual goods, the campaign manager also accesses the information that the client has allowed the campaign manager to access, such as the client's basic information (name, gender, age, etc.) and profile information (likes and dislikes, favorite activities, etc.). In a preferred embodiment of this invention, the campaign manager maintains a client database 395 for storing this information for each client. In this manner, the campaign manager may develop incentive campaigns that are specifically targeted to particular clients, or groups of clients.

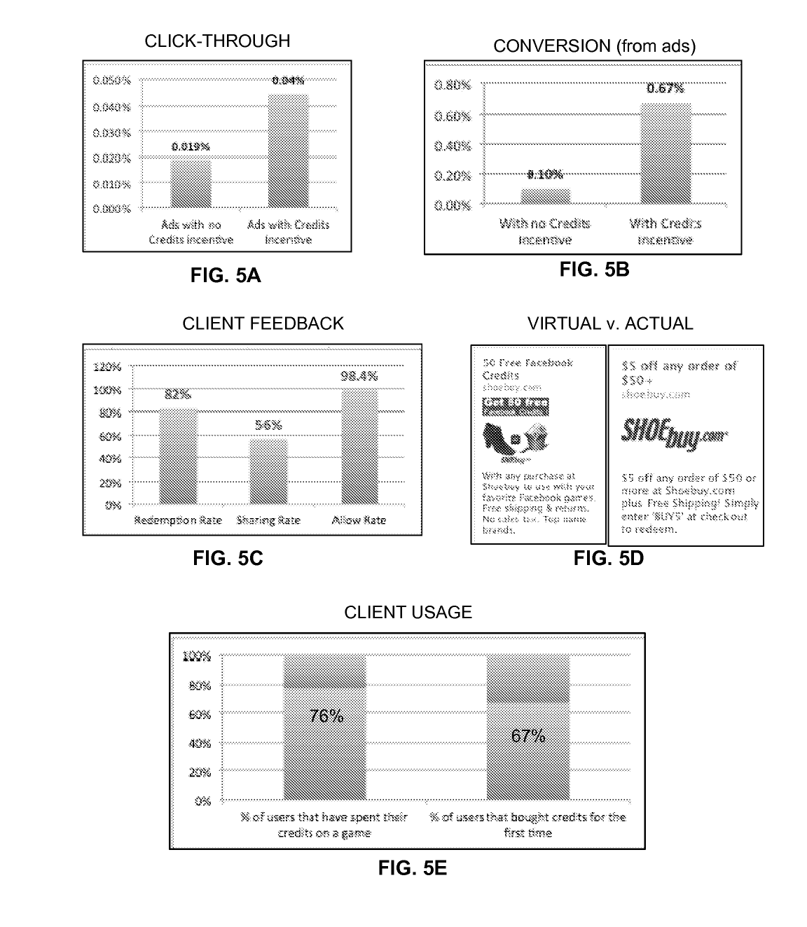

FIGS. 5A-5E illustrate performance metrics associated with embodiments of this invention during four retailer campaigns in 2010 that offered Facebook credits in return for purchases of actual goods. Over 100,000 clicks from advertisements were assessed, and over 10,000 virtual goods redemptions were processed.

FIG. 5A illustrates “click-through” rates associated with advertisements that did not include a virtual goods incentive (0.019%), and those that did (0.04%). That is, over twice as many clients proceeded to a next step in the shopping process when Facebook credits were offered in return for a purchase of the actual goods being advertised.

FIG. 5B illustrates “conversion” rates associated with advertisements that did not include a virtual goods incentive (0.10%), and those that did (0.67%). That is, over six times as many clients completed the action associated with the advertisement, such as making a purchase or other promoted action.

FIG. 5C illustrates the redemption rate, sharing rate, and allowance rate among clients that were qualified to receive the virtual goods. During these four campaigns, 82% of the clients that were eligible to receive the virtual goods proceeded to redeem the offer and have the virtual goods deposited into their virtual account. Of these clients, over half of them (56%) proceeded to publish a post, informing their friends of the virtual goods incentive.

As noted above, in a preferred embodiment, the campaign manager (or the retailer) requests permission to access the client's basic information, e-mail information, and profile information, as well allowing the campaign manager to post to their Facebook wall. During these four campaigns, almost every client (98.4%) that was eligible to receive the virtual goods agreed to allow the campaign manager to access this information.

FIG. 5D illustrates two advertisements that were placed on a retailer's web page at the same time, one for receipt of 50 Facebook credits, and one for an actual cash reduction of $5 off the purchase price. The nominal value of one Facebook credit is $0.10; accordingly, each of these advertisements was of equal nominal value. More clients chose the offer of 50 Facebook credits over the offer of $5 off; in a test case, the number of clients that chose the virtual Facebook credits was more than twice the number of clients that chose the cash reduction.

FIG. 5E illustrates that over two thirds (67%) of the clients that redeemed their offers for Facebook credits had never before obtained Facebook credits. That is, in combination with FIG. 5D, it can be seen that many clients who heretofore were presumably unwilling to spend actual funds to obtain Facebook credits were willing to forego a rebate of actual funds in favor of receiving Facebook credits in return for purchasing actual goods from the retailers.

FIG. 5E also illustrates that most of the clients (76%) had already spent their redeemed virtual credits within social gaming environments.

These statistics and metrics clearly indicate that offering virtual goods in return for the purchase of actual goods is indeed a very effective incentive, and often preferable to offers of actual cash rebates. Also, because virtual goods appear to be more valuable to clients than actual cash offers of similar nominal value, clients are more likely to return to the retailer that offers virtual goods than to retailers that only offer cash rebates.

Additionally, because clients who had never before purchased virtual goods are not reluctant to receive virtual credits in return for purchasing actual goods, the number of gamers that will be spending virtual credits while gaming can be expected to increase significantly.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any feasible combination thereof.

f) hardware portions may include a processor, and software portions may be stored on a non-transitory computer-readable medium, and may be configured to cause the processor to perform some or all of the functions of one or more of the disclosed elements;

g) hardware portions may be comprised of one or both of analog and digital portions;

h) any of the disclosed devices or portions thereof may be combined together or separated into further portions unless specifically stated otherwise;

i) no specific sequence of acts is intended to be required unless specifically indicated; and

j) the term “plurality of” an element includes two or more of the claimed element, and does not imply any particular range of number of elements; that is, a plurality of elements can be as few as two elements, and can include an immeasurable number of elements.

We claim:

1. A method comprising:
contracting with a retailer to provide a virtual goods incentive to encourage purchases of actual goods from the retailer,
receiving confirmation from the retailer to issue virtual goods to a client,
validating the confirmation, and if the confirmation is validated:
contacting the client,
confirming a virtual account associated with the client,
transferring the virtual goods to the virtual account
debiting an actual account associated with the retailer.

2. The method of claim 1, including
providing an interface from a web page associated with the retailer for communicating the confirmation from the retailer.

3. The method of claim 1, including
providing an interface from a web page associated with the retailer for communicating an advertisement for the virtual goods incentive to the web page.

4. The method of claim 1, wherein the confirmation includes an identifier of the confirmation that is unique to the retailer.

5. The method of claim 1, wherein the confirmation includes an encrypted element, and validating the confirmation includes decrypting the encrypted element using a key associated with the retailer.

6. The method of claim 5, wherein the confirmation includes an identifier of the confirmation that is unique to the retailer, and the encrypted element is based on the identifier of the confirmation.

7. The method of claim 1, wherein the virtual account is a Facebook account.

8. The method of claim 1, wherein the virtual goods include one or more Facebook credits.

9. The method of claim 1, wherein the virtual goods include one or more Farmville items.

10. The method of claim 1, including storing a profile associated with the client.

11. A method comprising:
presenting an advertisement from a retailer to a client for receiving virtual goods upon purchase of actual goods,
receiving a response from the client based on the advertisement,
processing the response from the client, and if the response is verified as a purchase of actual goods:
sending a confirmation to a third party, authorizing the third party to transfer the virtual goods to a virtual account associated with the client, and to debit an actual account associated with the retailer for an actual cost associated with the transfer of the virtual goods.

12. The method of claim 11, including
providing an interface from a web page associated with the retailer for communicating the confirmation to the third party.

13. The method of claim 11, including
providing an interface from a web page associated with the retailer for communicating the advertisement from the third party to the web page.

14. The method of claim 11, wherein the confirmation includes an identifier of the confirmation that is unique to the retailer.

15. The method of claim 11, wherein the confirmation includes an encrypted element that is encrypted using a key associated with the retailer.

16. The method of claim 15, wherein the confirmation includes an identifier of the confirmation that is unique to the retailer, and the encrypted element is based on the identifier of the confirmation.

17. The method of claim 11, wherein the virtual account is a Facebook account.

18. The method of claim 11, wherein the virtual goods include one or more Facebook credits.

19. The method of claim 11, wherein the virtual goods include one or more Farmville items.

20. A method comprising:
presenting an advertisement from a retailer to a client for receiving virtual goods in return for purchase of actual goods,
receiving a response from the client based on the advertisement,
verifying the response from the client, and if the response is verified as a purchase of actual goods:
obtaining an identifier of a virtual account associated with the client,
depositing the virtual goods to the identified virtual account.

21. The method of claim 20, wherein the virtual account is a Facebook account.

22. The method of claim 20, wherein the virtual goods include one or more Facebook credits.

23. The method of claim 20, wherein the virtual goods include one or more Farmville items.

24. The method of claim 20, including storing a profile associated with the client.
